(19) United States
(12) Patent Application Publication
(10) Pub. No.: US 2025/0065913 A1
(43) Pub. Date: Feb. 27, 2025

(54) REINFORCEMENT LEARNING (RL) POLICY WITH GUIDED META RL

(71) Applicants: Honda Motor Co., Ltd., Tokyo (JP); The Board of Trustees of the Leland Stanford Junior University, Stanford, CA (US)

(72) Inventors: Kanghoon LEE, Daejeon (KR); Jiachen LI, Mountain View, CA (US); David F. ISELE, Sunnyvale, CA (US); Jinkyoo PARK, Palo Alto, CA (US)

(21) Appl. No.: 18/455,056

(22) Filed: Aug. 24, 2023

(51) Int. Cl. B60W 60/00; G06N 3/092

(52) U.S. Cl. CPC B60W 60/0011; G06N 3/092; B60W 2555/60

(57) ABSTRACT

According to one aspect, a system for generating a reinforcement learning (RL) policy with guided meta RL is provided. The system may include a processor and a memory. The memory may store one or more instructions. The processor may execute one or more of the instructions stored on the memory to perform one or more acts, actions, and/or steps, such as generating an initial RL policy for an ego-vehicle based on an intelligent driver model (IDM), generating a set of RL guiding policies for a set of social agents based on the initial RL policy and a set of preferences, generating a meta-RL guided policy based on the set of RL guiding policies, and generating a RL policy with guided meta RL for the ego-vehicle based on the meta-RL guided policy and the IDM.

### BACKGROUND

One challenge with respect to reinforcement learning (RL) for autonomous driving is maintaining or improving the robustness of any learned driving policies of autonomous vehicles (e.g., ego-agents) to variations in driving policies of human-driven vehicles (e.g., social agents). In real-world settings, autonomous vehicles may be exposed to driving behaviors that are not necessarily similar to those seen during training. Existing methods for training RL policies involve social agents whose policies are well-defined by the simulator. This is not ideal because simulated policies are fixed and not diverse, implying that the learned ego-agent's policy tends to over-fit the simulated behaviors of social agents. The challenge lies in finding a systematic way to generate new and diverse policies for social agents that could represent human-like behaviors to enhance the robustness of ego policies.

### BRIEF DESCRIPTION

According to one aspect, a system for generating a reinforcement learning (RL) policy with guided meta RL may include a processor and a memory. The memory may store one or more instructions. The processor may execute one or more of the instructions stored on the memory to perform one or more acts, actions, and/or steps, such as generating an initial RL policy for an ego-vehicle, generating a set of RL guiding policies for a set of social agents based on the initial RL policy and a set of preferences, generating a meta-RL guided policy based on the set of RL guiding policies, and generating a RL policy with guided meta RL for the ego-vehicle based on the meta-RL guided policy.

Generating the initial RL policy for the ego-vehicle may be based on an intelligent driver model (IDM). The set of preferences utilized to generate the set of RL guiding policies may be indicative of a level of aggressiveness. Generating the meta-RL guided policy may be based on proximal policy optimization (PPO). Generating the meta-RL guided policy may be based on regularization for the set of RL guiding policies.

Generating the set of RL guiding policies for the set of social agents may be based on a graph neural network (GNN), a gated recurrent unit (GRU), or a multi-layer perceptron (MLP). Generating the meta-RL guided policy may be based on a graph neural network (GNN), a gated recurrent unit (GRU), or a multi-layer perceptron (MLP). Generating the RL policy with guided meta RL for the ego-vehicle may be based on an intelligent driver model (IDM) and the initial RL policy. The meta-RL guided policy may generalize behavior according to a desired preference from the set of preferences. The set of RL guiding policies may be generated based on a reward function.

According to one aspect, a computer-implemented method for generating a reinforcement learning (RL) policy with guided meta RL may include generating an initial RL policy for an ego-vehicle, generating a set of RL guiding policies for a set of social agents based on the initial RL policy and a set of preferences, generating a meta-RL guided policy based on the set of RL guiding policies, and generating a RL policy with guided meta RL for the ego-vehicle based on the meta-RL guided policy.

Generating the initial RL policy for the ego-vehicle may be based on an intelligent driver model (IDM). The set of preferences utilized to generate the set of RL guiding policies may be indicative of a level of aggressiveness. Generating the meta-RL guided policy may be based on proximal policy optimization (PPO). Generating the meta-RL guided policy may be based on regularization for the set of RL guiding policies.

Generating the set of RL guiding policies for the set of social agents may be based on a graph neural network (GNN), a gated recurrent unit (GRU), or a multi-layer perceptron (MLP). Generating the meta-RL guided policy may be based on a graph neural network (GNN), a gated recurrent unit (GRU), or a multi-layer perceptron (MLP). Generating the RL policy with guided meta RL for the ego-vehicle may be based on an intelligent driver model (IDM) and the initial RL policy. The meta-RL guided policy may generalize behavior according to a desired preference from the set of preferences.

According to one aspect, a reinforcement learning (RL) policy with guided meta RL vehicle may include a controller, one or more vehicle systems, a memory, and a processor. The memory may store one or more instructions for a RL policy with guided meta RL. The processor may execute one or more of the instructions stored on the memory to control one or more of the vehicle systems to operate according to the RL policy with guided meta RL. The RL policy with guided meta RL may be generated by generating an initial RL policy for an ego-vehicle, generating a set of RL guiding policies for a set of social agents based on the initial RL policy and a set of preferences, generating a meta-RL guided policy based on the set of RL guiding policies, and generating the RL policy with guided meta RL for the ego-vehicle based on the meta-RL guided policy.

### BRIEF DESCRIPTION OF THE DRAWINGS

FIGS. 1A-1C are exemplary illustrations of traffic scenarios in an operating environment, according to one aspect.

FIG. 2 is an exemplary flow diagram of a computer-implemented method for generating a reinforcement learning (RL) policy with guided meta RL, according to one aspect.

FIGS. 3A-3B are exemplary architectures in association with generating a reinforcement learning (RL) policy with guided meta RL, according to one aspect.

FIG. 4 is an exemplary component diagram of a system for generating a reinforcement learning (RL) policy with guided meta RL, according to one aspect.

FIG. 5 is an exemplary flow diagram of a computer-implemented method for generating a reinforcement learning (RL) policy with guided meta RL, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

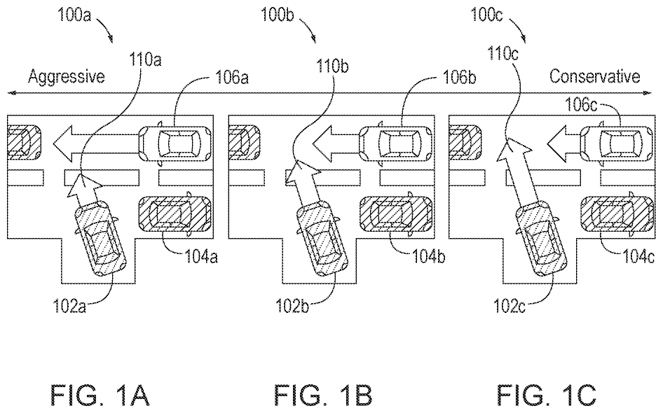

FIGS. 1A-1C are exemplary illustrations of traffic scenarios 100a, 100b, 100c in an operating environment, according to one aspect. Generally, in an intersection, such as a T-intersection as depicted in FIGS. 1A-1C, multiple vehicles (e.g., social agents 104a, 104b, 104c, 106a, 106b, 106c) on a two-lane roadway may be driving horizontally and an ego-vehicle 102a, 102b, 102c on a vertical roadway may be trying to merge into the upper lane on the two-lane roadway. In this scenario, one objective for each vehicle may be to reach its destination while minimizing any possibility of collision. Social agents may exhibit different behaviors based on their preferences or based on internal characteristics in traffic scenarios 100a, 100b, 100c, while the left-turn 110a, 110b, 110c ego-vehicle 102a, 102b, 102c may react differently based behaviors of social agents. For example, in FIG. 1A, the ego-vehicle 102a may yield to the social agent 106a. In FIG. 1B, the ego-vehicle 102b may consider yielding to the social agent 106b. In FIG. 1C, the ego-vehicle 102c may make the left turn 110c ahead of the social agent 106c.

Systems, techniques, and methods for generating a reinforcement learning (RL) policy with guided meta RL are described herein and with reference to the “PROBLEM FORMULATION” below.

### Problem Formulation

An intersection scenario, such as the T-intersection scenario of FIGS. 1A-1C may be formulated as a Partially Observable Stochastic Game (POSG) representing a discrete-time stochastic control process. The POSG may be defined as a ( [symbol] , [symbol] , [symbol] , [symbol] , [symbol] , T) tuple.

1) Agent: [symbol] may be a set of agent indices associated with one or more agents. An individual vehicle may be defined as a decision-making agent. Agents may include an ego-vehicle (e.g., ego-agent) and one or more other traffic participants (e.g., other vehicles) or social agents. As used herein, ego-vehicle and ego-agent may be used interchangeably. Similarly, social vehicle and social agent may be used interchangeably. Each agent may be indexed with i∈ [symbol] = [symbol] _{E}∪ [symbol] _{S}, [symbol] _{E}={0}, which may be the index set of the ego-vehicle that is trying to merge into the upper lane on the two-lane roadway and [symbol] _{S}={1, . . . , n} may be the index set of social agents that drive horizontally with respect to FIGS. 1A-1C.

2) State: [symbol] may be the set of states. A physical state of each agent xⁱ∈ [symbol] ⁴ may include its position and velocity. Additionally, the social agents may have a preference level βⁱ∈ [symbol] that regulates the degree of aggressiveness with respect to the ego-vehicle. A global state s∈ [symbol] may be defined as:

$$s = [ {x}^{0} , ( {x}^{1} , {β}^{i} ) , ( {x}^{2} , {β}^{2} ) , … , ( {x}^{n} , {β}^{n} ) ] \qquad ( 1 )$$

3) Observation: [symbol] = [symbol] ⁰× [symbol] ¹× . . . × [symbol] ⁿ on may be the set of joint observations of all agents. In real-world scenarios, it may not be natural to directly observe the internal preference of surrounding vehicles. Therefore, the ego-vehicle may merely observe the physical state of each agent and infer their internal preference using an inference model. However, to simplify the environment, it may be assumed that the social agents may access the true global state, which includes internal preference or true preference:

$${o}^{i} = \{ \begin{matrix}[ {x}^{0} , {x}^{1} , … , {x}^{n} ] & if i ∈ {𝒥}_{E} , \\ [ {x}^{0} , ( {x}^{1} , {β}^{i} ) , … , ( {x}^{n} , {β}^{n} ) ] & if i ∈ {𝒥}_{S}\end{matrix} . \qquad ( 2 )$$

4) Action: [symbol] = [symbol] ⁰× [symbol] ¹× . . . × [symbol] ⁿ An may be a set of joint action space of all agents. Action space, [symbol] ⁱ may be defined by a set of candidate velocities, represented by [symbol] ⁱ={0.0,0.5,3.0}m/s for i∈ [symbol] . The action of each agent may control the desired velocity of its own low-level controller or controller.

5) Reward: [symbol] : [symbol] × [symbol] → [symbol] ^{N} may be the reward for each agent. The base reward rⁱ for each agent may be designed to encourage the learning agent, ego-agent, or ego-vehicle to navigate the intersection with maximum velocity and minimum collision risk, which may be defined as:

$${r}^{i} ( s , a ) = \{ \begin{matrix}{r}_{goal} & if s ∈ {𝒮}_{goal}^{i} , \\ {r}_{fail} & if s ∈ {𝒮}_{fail}^{i} , \\ {r}_{veloctiy} \times ‖ {v}^{i} ‖ & otherwise\end{matrix} , \qquad ( 3 )$$

where [symbol] _{goal}ⁱ may be a state set indicating success scenarios where agent i has reached its goal, while [symbol] _{fail}ⁱ may be a state set indicating failure scenarios where a collision occurs or the ego-vehicle goes off the roadway. νⁱ may represent the velocity of agent i.

The ego-vehicle may use its base reward as a final reward denoted by Rⁱ. However, social agents may use a final reward which may be defined as the sum of its own base reward and a base reward of the ego-vehicle weighted by its preference:

$${R}^{i} ( s , a ) = \{ \begin{matrix}{r}^{0} ( s , a ) & if i ∈ {𝒥}_{E} , \\ {r}^{i} ( s , a ) + {β}^{i} {r}^{0} ( s , a ) & if i ∈ {𝒥}_{S}\end{matrix} , \qquad ( 4 )$$

where βⁱ may denote the preference of agent i. A level of aggressiveness (e.g., from low to medium to high, on a scale from 0-100, etc.) may be manipulated in the policy objective by modifying the preference using this reward design. For example, a negative β value may encourage minimizing the reward of the ego-vehicle, preventing it from making a left turn. Conversely, a positive β value may encourage maximizing the reward of the ego-vehicle, which may encourage the social agents to yield.

6) Transition: [symbol] : [symbol] × [symbol] → [symbol] may be a function that determines the next state given a current state and a current action. The transition model of the simulation may operate with a time interval Δt of 0.1 s. Each social agent may be assigned a straight waypoint that leads towards the end of the roadway, while the ego-vehicle may have a straight waypoint initially and then a circular waypoint when merging into the upper roadway. The velocities of all agents may be updated using low-level controllers and actions that follow the waypoints. The position of each agent may be deterministically updated based on their previous positions (pₜ^{x}, pₜ^{y}) and velocities (νₜ^{x}, νₜ^{y}) as follows:

$${p}_{t + 1}^{x} = {p}_{t}^{x} + {v}_{t}^{x} \cdot Δ t \qquad ( 5 )$$

$${p}_{t + 1}^{y} = {p}_{t}^{y} + {v}_{t}^{y} \cdot Δ t \qquad ( 6 )$$

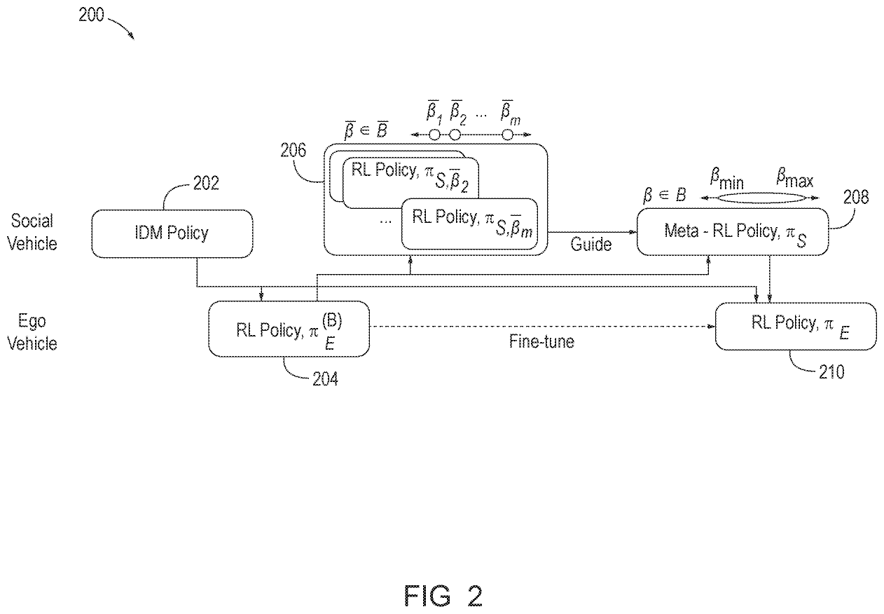

FIG. 2 is an exemplary flow diagram of a computer-implemented method for generating a reinforcement learning (RL) policy with guided meta RL, according to one aspect. One goal may be to train an ego-vehicle that may effectively interact with a diverse group of social agents and generalize their behavior to unseen or unknown situations or scenarios. The objective of the ego-vehicle may be formulated as:

$${π}_{E}^{*} = {arg max}_{{π}_{E} ∈ {\prod }_{E}} {\sum }_{{π}_{S} ∈ {\prod }_{S}} {𝔼}_{{s}_{t} , {a}_{t}} [ {\sum }_{t = 0}^{∞} {γ}^{t} R ( {s}_{t} , {a}_{t} ) ] \qquad ( 7 )$$

where π_{E} and π_{S} may represent the policies for the ego-vehicle and social agent, respectively. Similarly, Π_{E} and Π_{S} may represent the feasible policy sets for the ego-vehicle and social agent, respectively. γ may represent the discount factor. The initial state s₀ may be sampled from the initial state distribution p(·). At each time step t, the action aₜ may be sampled using the policies for both the ego-vehicle and social agents, and the next state sₜ may be sampled using the transition function based on the previous state and action. The computer-implemented method for generating the RL policy with guided meta RL may include two stages.

The first stage may be to learn diverse RL policies of social agents using the reward functions designed to emphasize interactions with the ego-vehicle, which may be achieved by the meta-RL method effectively. In the first stage, RL policies may be trained which cover one single preference (e.g., β), and this may be performed multiple times (e.g., to have m number of single objective policies).

The second stage may be to learn an ego-vehicle's policy that identifies the internal preference of each social agent based on their past behavior and makes decisions accordingly. The overall training process for generating the RL policy with guided meta RL may be seen in FIG. 2. In the second stage, the meta-RL guided policy may be trained and β may be sampled B={βₘᵢₙ≤β≤βₘₐₓ}.

Training Reinforcement Learning (RL) Policy with Guided Meta RL

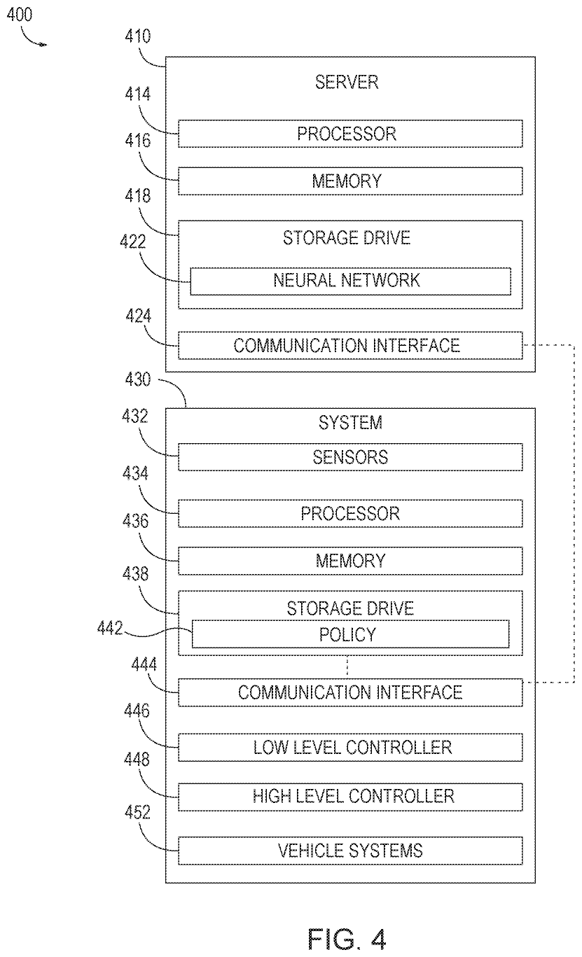

A two-stage policy learning method may be implemented via the server of FIG. 4 which enables learning of the social agents' policy to generate diverse behaviors with a wide range of preferences.

In the first stage, in order to train a guiding policy π_{S,β}(α|o) that corresponds to a specific preference β, the objective of the guiding policy for β may be written as:

$${π}_{S , β}^{*} = {arg max}_{{π}_{S} ∈ {\prod }_{S}} {𝔼}_{{s}_{t} , {a}_{t}} [ {\sum }_{t = 0}^{T} {γ}^{t} {R}_{t}^{i} ( {s}_{t} , {a}_{t} ) ] = {arg max}_{{π}_{S} ∈ {\prod }_{S}} {𝔼}_{{s}_{t} , {a}_{t}} [ {\sum }_{t = 0}^{T} {γ}^{t} ( {r}_{t}^{i} ( {s}_{t} , {a}_{t} ) + β {r}_{t}^{0} ( {s}_{t} , {a}_{t} ) ) ] \qquad ( 8 )$$

Multiple guiding policies may be trained based on a limited set of preferences B̅={β̅¹, . . . , β̅^{m}} using a model-free RL algorithm, such as Proximal Policy Optimization (PPO), resulting in m number of guiding policies π*_{S,β̅}_{¹}, . . . , π*_{S,β̅}_{^{m}}. Each policy here may cover one specific preference.

In the second stage, a meta-policyπ_{S}(α|o, β) may be trained to generalize the behavior according to its preference. Unlike the first stage where the policy may be trained on a limited set of preferences, the meta-policy of the second stage may be trained on a broader range of preference sets B={β|βₘᵢₙ≤β≤βₘₐₓ}. Learning a meta-policy that may simultaneously handle a wide range of preferences may be challenging. To achieve this goal, regularization techniques may be applied to the metapolicy to mimic the behaviors of the guiding policies for the pre-trained preferences. This approach enables the metapolicy to learn behaviors with new preferences efficiently while retaining the ability to perform well with the preferences for guiding policies. The regularization for guiding policies may be:

$${ℒ}_{reg} ( θ ) = {\sum }_{\overline{β} ∈ \overline{B}} ( \vert \overline{β} - β \vert \leq d ) {D}_{KL} ( {π}_{S , \overline{β}}^{*} ( \cdot \vert o ) ‖ {π}_{S} ( \cdot \vert o , β ) ) \qquad ( 9 )$$

where d may denote the guide distance. When preferences are sampled from a continuous space, as opposed to a discrete space in the first stage, it may become infeasible to sample preferences within a limited preference set B̅. Therefore, if the sampled preference β is sufficiently close to any preference β̅∈B̅, the meta-policy π_{S} may be encouraged to mimic the guiding policy π*_{S,β̅} as a regularization strategy. Thus, when the preference is sufficiently close to one of the m number of guiding policies, the regularization of Equation (9) may be activated.

Finally, the parameter of meta-policy may be updated using a weighted sum of a PPO loss and the regularization loss in Equation (9), which may be written as:

$$ℒ ( θ ) = {ℒ}_{PPO} ( θ ) + {w}_{reg} {ℒ}_{reg} ( θ ) \qquad ( 10 )$$

where w_{reg} may denote the weight for the regularization loss. Thus, when the preference is not sufficiently close to one of the m number of guiding policies, the PPO loss of Equation (10) may be activated.

To facilitate the learning of the social policy, a rational ego-vehicle's behavior may be utilized. Since designing the ego behavior based on pre-defined rules may be challenging and may not generalize well, an RL-based ego driving policy may be adopted, π_{E}^{(B)}. This RL-based policy may be demonstrated with effective interactions with social agents controlled by an Intelligent Driver Model (IDM), for example.

In FIG. 2, a training framework for social driving meta-policy and robust ego driving policy generation 200 may be provided. 202, 206, 208 may represent the social agents' policies while 204, 210 may represent the ego-vehicles' policies, respectively. The ego-vehicle's initial reinforcement learning (RL) policy 204 may initially be trained with an IDM policy 202 based social agents as its training environment. Then, the set of RL guiding policies 206 with a limited preference set may be trained, followed by training a meta-RL guided policy 208 on a broader preference set and using the guiding loss, regularization loss, and the PPO loss. Thereafter, the ego-vehicle's updated policy or RL policy with guided meta RL 210 may be trained in the environment that includes the social agents with both the meta-RL guided policy 208 and the IDM policy 202.

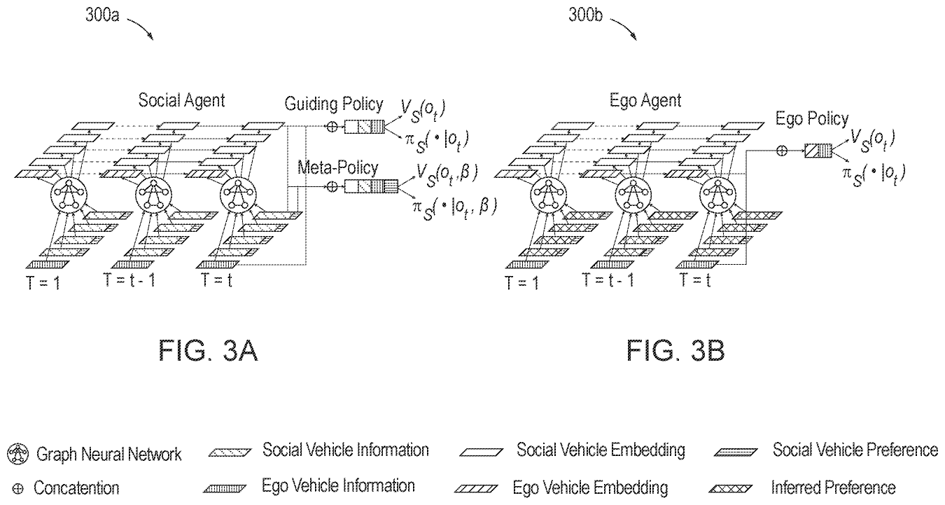

FIGS. 3A-3B are exemplary architectures 300a, 300b in association with generating a reinforcement learning (RL) policy with guided meta RL, according to one aspect. FIG. 3A is an exemplary illustration of a policy and value network architecture 300a for the social agents. FIG. 3B is an exemplary illustration of a policy and value network architecture 300b for the ego-vehicle.

FIG. 4 is an exemplary component diagram of a system 100 for generating a reinforcement learning (RL) policy with guided meta RL, according to one aspect. The system 100 for generating a RL policy with guided meta RL may include a server 410 portion. Additionally, a RL policy with guided meta RL system 430 or vehicle may utilize the RL policy with guided meta RL generated by the server 410.

The server 410 may be the system 100 for generating a RL policy with guided meta RL and may include a processor 414, a memory 416, a storage drive 418 storing a neural network 422, and a communication interface 424. The memory 416 may store one or more instructions. The processor 414 may execute one or more of the instructions stored on the memory to perform one or more acts, actions, and/or steps, such as generating an initial RL policy for an ego-vehicle, generating a set of RL guiding policies for a set of social agents based on the initial RL policy and a set of preferences, generating a meta-RL guided policy based on the set of RL guiding policies, and generating a RL policy with guided meta RL for the ego-vehicle based on the meta-RL guided policy. The processor 414 may perform any of the above described acts, actions, or steps from the “PROBLEM FORMULATION” or “TRAINING REINFORCEMENT LEARNING (RL) POLICY WITH GUIDED META RL”. The neural network 422 may be any neural network, such as a graph neural network (GNN), a gated recurrent unit (GRU), a multi-layer perceptron (MLP), a convolutional neural network (CNN), a recurrent neural network (RNN), a long-short term memory (LSTM) network, a multi-layer perceptron (MLP), etc.

Generating the initial RL policy for the ego-vehicle may be based on an intelligent driver model (IDM). The set of preferences utilized to generate the set of RL guiding policies may be indicative of a level of aggressiveness. Generating the meta-RL guided policy may be based on proximal policy optimization (PPO). Generating the meta-RL guided policy may be based on regularization for the set of RL guiding policies. Generating the RL policy with guided meta RL for the ego-vehicle may be based on an IDM and the initial RL policy. In this way, the RL policy with guided meta RL may be fine-tuned.

Generating the set of RL guiding policies for the set of social agents may be based on a GNN, a GRU, a MLP, a CNN, a RNN, a LSTM, an MLP, etc. Generating the meta-RL guided policy may be based on a GNN, a GRU, a MLP, a CNN, a RNN, a LSTM, an MLP, etc. The meta-RL guided policy may generalize behavior according to a desired preference from the set of preferences. The set of RL guiding policies may be generated based on a reward function (e.g., a goal reward and a failure reward, and a speed reward).

The RL policy with guided meta RL system 430 may include sensors 432, a processor 434, a memory 436, a storage drive 438 storing a policy 442 (e.g., the RL policy with guided meta RL described above) received from the server 410, a communication interface 444, a low-level controller 446, a high-level controller 448, and one or more vehicle systems 452. The communication interface 424 of the server 410 may be in computer communication or communicatively coupled with the communication interface 444 of the RL policy with guided meta RL system 430 and may transmit the RL policy with guided meta RL (e.g., after generation) to the RL policy with guided meta RL system 430 for implementation. The RL policy with guided meta RL system 430 may be a vehicle or an autonomous vehicle (AV), according to one aspect. The sensors 432 may detect one or more other vehicle (e.g., social vehicle) in a real-world or operating environment, as well as features of the operating environment, such as the roadway, pedestrians, walkways, etc.

The memory 436 or storage drive 438 may store one or more instructions for a RL policy with guided meta RL or the policy 442. The processor 434 may execute one or more of the instructions stored on the memory 436 to control, using low-level controller 446 and high-level controller 448, one or more of the vehicle systems 452 to operate according to the RL policy with guided meta RL or the policy 442. The low-level controller 446 may be a hardware device that collects sensor feedback from the sensor 432, condition and filter the measurements, send actuator inputs, and network with the high-level controller 448 at a real-time rate. The high-level controller 448 may control one or more control inputs, such as steering, throttle, and brake. One or more of the vehicle systems 452 may include one or more actuators or motors, and may also include an autonomous driving system and a global positioning system (GPS), for example. The RL policy with guided meta RL may be generated by generating an initial RL policy for an ego-vehicle, generating a set of RL guiding policies for a set of social agents based on the initial RL policy and a set of preferences, generating a meta-RL guided policy based on the set of RL guiding policies, and generating the RL policy with guided meta RL for the ego-vehicle based on the meta-RL guided policy. Due to the guiding loss and the PPO loss, the meta-RL guided policy may have the benefit or advantage of enhanced robustness for diverse behavior.

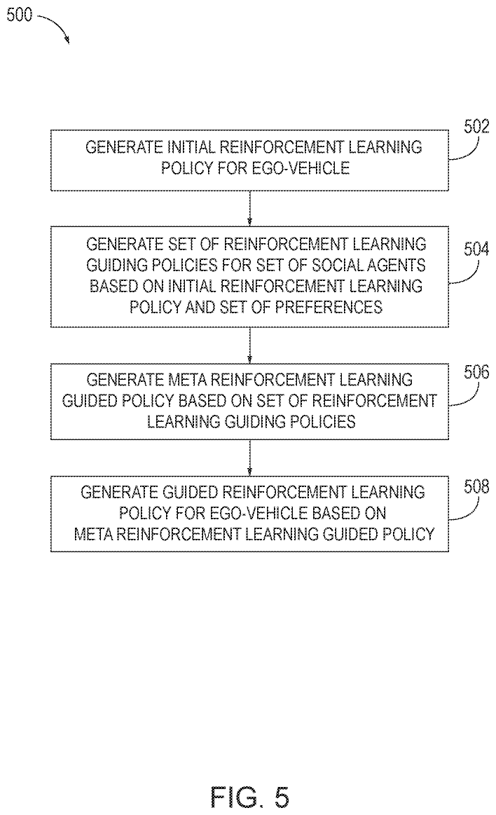

FIG. 5 is an exemplary flow diagram of a computer-implemented method 500 for generating a reinforcement learning (RL) policy with guided meta RL, according to one aspect. The computer-implemented method for generating a RL policy with guided meta RL may include generating 502 an initial RL policy for an ego-vehicle, generating 504 a set of RL guiding policies for a set of social agents based on the initial RL policy and a set of preferences, generating 506 a meta-RL guided policy based on the set of RL guiding policies, and generating 508 a RL policy with guided meta RL for the ego-vehicle based on the meta-RL guided policy.

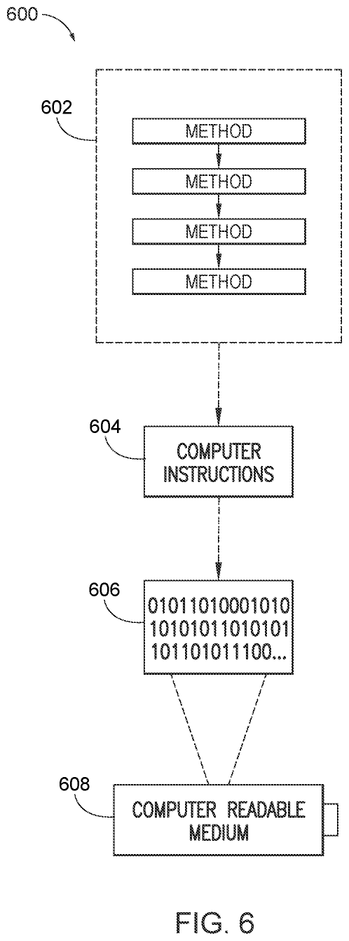

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the computer-implemented method 200 of FIG. 2 or the computer-implemented method 500 of FIG. 5. In another aspect, the processor-executable computer instructions 604 may be configured to implement a system, such as the system 400 for generating a RL policy with guided meta RL of FIG. 4. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

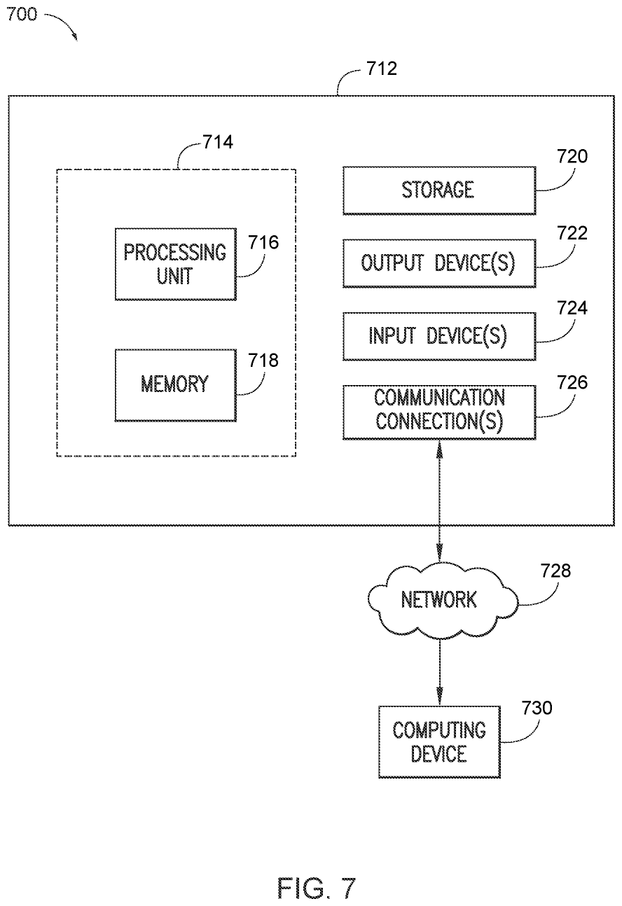

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions may be combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for generating a reinforcement learning (RL) policy with guided meta RL, comprising:
a memory storing one or more instructions;
a processor executing one or more of the instructions stored on the memory to perform:
generating an initial RL policy for an ego-vehicle;
generating a set of RL guiding policies for a set of social agents based on the initial RL policy and a set of preferences;
generating a meta-RL guided policy based on the set of RL guiding policies; and
generating a RL policy with guided meta RL for the ego-vehicle based on the meta-RL guided policy.

2. The system for generating the RL policy with guided meta RL of claim 1, wherein generating the initial RL policy for the ego-vehicle is based on an intelligent driver model (IDM).

3. The system for generating the RL policy with guided meta RL of claim 1, wherein the set of preferences utilized to generate the set of RL guiding policies are indicative of a level of aggressiveness.

4. The system for generating the RL policy with guided meta RL of claim 1, wherein generating the meta-RL guided policy is based on proximal policy optimization (PPO).

5. The system for generating the RL policy with guided meta RL of claim 1, wherein generating the meta-RL guided policy is based on regularization for the set of RL guiding policies.

6. The system for generating the RL policy with guided meta RL of claim 1, wherein generating the set of RL guiding policies for the set of social agents is based on a graph neural network (GNN), a gated recurrent unit (GRU), or a multi-layer perceptron (MLP).

7. The system for generating the RL policy with guided meta RL of claim 1, wherein generating the meta-RL guided policy is based on a graph neural network (GNN), a gated recurrent unit (GRU), or a multi-layer perceptron (MLP).

8. The system for generating the RL policy with guided meta RL of claim 1, wherein generating the RL policy with guided meta RL for the ego-vehicle is based on an intelligent driver model (IDM) and the initial RL policy.

9. The system for generating the RL policy with guided meta RL of claim 1, wherein the meta-RL guided policy generalizes behavior according to a desired preference from the set of preferences.

10. The system for generating the RL policy with guided meta RL of claim 1, wherein the set of RL guiding policies is generated based on a reward function.

11. A computer-implemented method for generating a reinforcement learning (RL) policy with guided meta RL, comprising:
generating an initial RL policy for an ego-vehicle;
generating a set of RL guiding policies for a set of social agents based on the initial RL policy and a set of preferences;
generating a meta-RL guided policy based on the set of RL guiding policies; and
generating a RL policy with guided meta RL for the ego-vehicle based on the meta-RL guided policy.

12. The computer-implemented method for generating the RL policy with guided meta RL of claim 11, wherein generating the initial RL policy for the ego-vehicle is based on an intelligent driver model (IDM).

13. The computer-implemented method for generating the RL policy with guided meta RL of claim 11, wherein the set of preferences utilized to generate the set of RL guiding policies are indicative of a level of aggressiveness.

14. The computer-implemented method for generating the RL policy with guided meta RL of claim 11, wherein generating the meta-RL guided policy is based on proximal policy optimization (PPO).

15. The computer-implemented method for generating the RL policy with guided meta RL of claim 11, wherein generating the meta-RL guided policy is based on regularization for the set of RL guiding policies.

16. The computer-implemented method for generating the RL policy with guided meta RL of claim 11, wherein generating the set of RL guiding policies for the set of social agents is based on a graph neural network (GNN), a gated recurrent unit (GRU), or a multi-layer perceptron (MLP).

17. The computer-implemented method for generating the RL policy with guided meta RL of claim 11, wherein generating the meta-RL guided policy is based on a graph neural network (GNN), a gated recurrent unit (GRU), or a multi-layer perceptron (MLP).

18. The computer-implemented method for generating the RL policy with guided meta RL of claim 11, wherein generating the RL policy with guided meta RL for the ego-vehicle is based on an intelligent driver model (IDM) and the initial RL policy.

19. The computer-implemented method for generating the RL policy with guided meta RL of claim 11, wherein meta-RL guided policy generalizes behavior according to a desired preference from the set of preferences.

20. A reinforcement learning (RL) policy with guided meta RL system, comprising:
a controller;
one or more vehicle systems;
a memory storing one or more instructions for a RL policy with guided meta RL; and
a processor executing one or more of the instructions stored on the memory to control one or more of the vehicle systems to operate according to the RL policy with guided meta RL,
wherein the RL policy with guided meta RL is generated by:
generating an initial RL policy for an ego-vehicle;
generating a set of RL guiding policies for a set of social agents based on the initial RL policy and a set of preferences;
generating a meta-RL guided policy based on the set of RL guiding policies; and
generating the RL policy with guided meta RL for the ego-vehicle based on the meta-RL guided policy.
